(19) United States
(12) Patent Application Publication
(10) Pub. No.: US 2006/0164036 A1
(43) Pub. Date: Jul. 27, 2006

(54) Systems for powering peripheral devices

(75) Inventors: Imran Ulla, Austin, TX (US); Mark Rylander, Austin, TX (US)

Correspondence Address: FORTKORT GRETHER & KELTON LLP, 9442 N. Capital of Texas Hwy., Arboretum Plaza One, Suite 500, AUSTIN, TX, 78759, US

(73) Assignee: Motion Computing, Inc.

(21) Appl. No.: 11/040,840

(22) Filed: Jan. 21, 2005

(51) Int. Cl. H02J 7/00

(52) U.S. Cl. 320/114

(57) ABSTRACT

A device is provided for employing batteries for mobile computing system to provide separate power sources for peripherals for mobile computing systems. A device is provided for charging batteries for mobile computing devices which can also be used to power peripherals for mobile computing systems.

### TECHNICAL FIELD

The present invention relates generally to Power for electronic devices. More specifically, the invention relates to providing power to personal computing systems peripheral devices that require separate power supply.

### BACKGROUND OF THE INVENTION

Motion Computing, Inc. (Motion) of Austin, Tex. has been at the forefront of new paradigms related to tablet and slate computers and their applications in organizational and personal computing. One particular area of development has been providing power for users requiring ultra portable systems.

Ultra portable computer devices typically have separate power supplies. For example most laptop, slate and tablet computers have an onboard battery so that they can be operated without accessing mains power (a utility power grid) by plugging into a power outlet. Users of these portable computing devices frequently make use of peripheral devices. Some of these devices are the same types of devices that are used with a desktop workstation; some are designed for greater portability. However, many of these devices require power and do not have a rechargeable battery on board. These devices need access to the power grid through a transformer that converts the AC power to an appropriate DC source. Ultra mobile computer users have need for an improved system for powering their peripheral devices.

### BRIEF DESCRIPTION OF THE DRAWINGS

A better understanding of the present invention can be obtained when the following detailed description of the disclosed embodiments is considered in conjunction with the following drawings, in which:

FIG. 1 illustrates an example of a typical computing system with prior art powered peripheral devices;

FIG. 2 illustrates an improved system for powering peripheral devices for a ultra mobile computer system;

FIG. 3 illustrates of a battery being inserted into the portable power supply;

FIG. 4; illustrates an embodiment of the electrical connections to the portable power supply;

FIG. 5 illustrates the functional blocks of an embodiment of the portable power supply embodiment of FIG. 4;

FIG. 6 illustrates an alternative embodiment of the portable power supply;

FIG. 7 illustrates the electrical connections to the portable power supply embodiment of FIG. 6;

FIG. 8 illustrates an alternative embodiment of a portable power supply employing multiple batteries;

FIG. 9 illustrates and an alternative embodiment for powering peripheral devices;

FIG. 10 illustrates the side view of the embodiment illustrated in FIG. 9; and

FIG. 11 illustrates an alternative embodiment of pass-through charging of the peripheral power device.

### DETAILED DESCRIPTION OF THE FIGURES

Although described with particular reference to a tablet computing device, the claimed subject matter can be implemented in any system requiring powering of peripheral devices. Those with skill in the computing arts will recognize that the disclosed embodiments have relevance to a wide variety of computing environments in addition to those described below. In addition, the portions of the system and methods of the disclosed invention can be implemented in software, hardware, or in differing combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

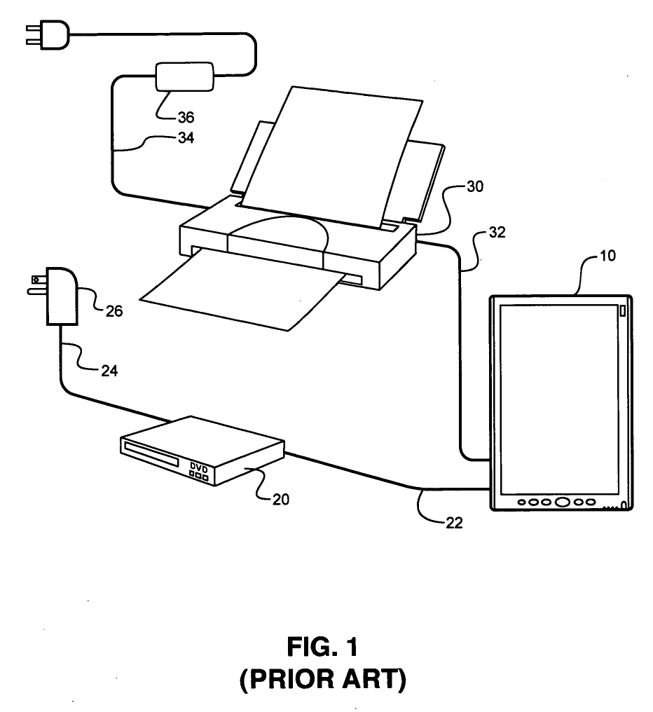

FIG. 1 illustrates a typical mobile computer system incorporating the use of peripheral devices. The illustrated system is comprised of a personal computer 10. One of the peripherals illustrated is a DVD/CD player 20 which is connected to the personal computer 10 by a data cable 22. This data cable can employ many different industry standard protocols. By way of example this cable is a cable that uses the Firewire protocol and the cable is a Firewire cable. Though Firewire cables can supply power to some peripheral devices other Firewire compatible peripheral devices require a separate power supply. For example in FIG. 1 the DVD/CD player 20 is requires power from a power cable 24 which is includes a AC to DC transformer 26 which converts the power from a socket (not shown) connected to a utility power grid (not shown). The system illustrated also includes a printer 30 which is connected to the personal computer 10 via a separate data cable 32. The illustrated printer is a USB protocol compatible peripheral using a USB cable. Like Firewire, the USB is capable of providing limited power. In this case however, the printer 30 requires a separate power connection through a power cable 34 which includes an AC/DC power transformer 36 which converts the utility provided power (not shown) to DC power appropriate to the peripheral device. This typical implementation of a mobile computing system is insufficiently mobile because the peripheral devices require access to the utility power grid to function.

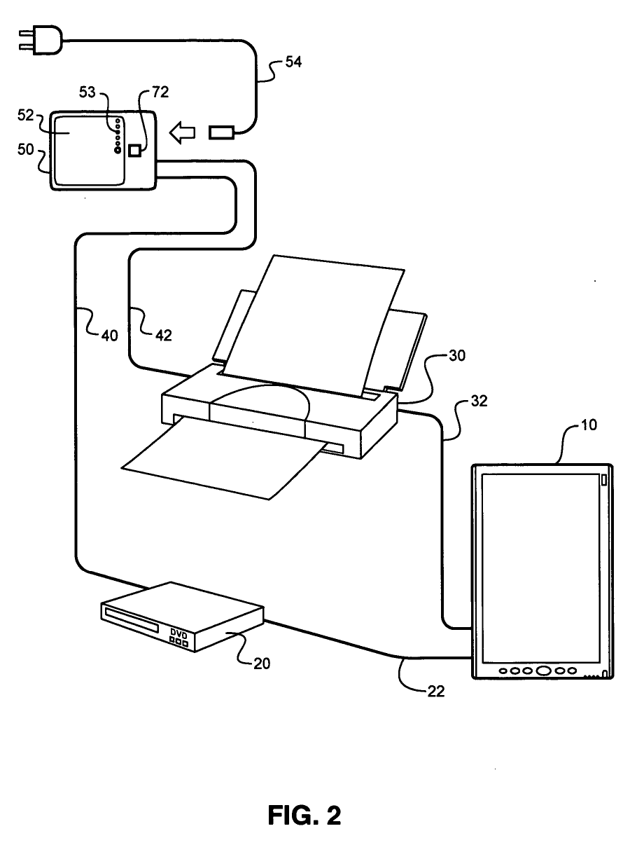

FIG. 2 illustrates an improved system for providing power to peripherals for a mobile computer system. In this system the personal computer 10 is connected to a DVD/CD player 20 via a data cable 22 and a printer 30 via a data cable 32. In the embodiment illustrated in FIG. 2 the peripheral power supply includes a removable rechargeable battery 52 and a connector (not shown) for connecting the peripheral power supply 50 to a power cable 54 for connecting the peripheral power supply to the power from the utility grid (not shown).

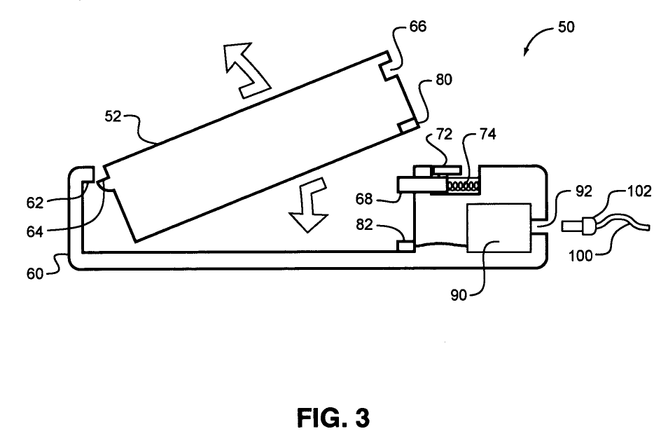

FIG. 3 illustrates in greater detail the peripheral power supply 50 from FIG. 2. The embodiment illustrated includes a main housing 60 for receiving a rechargeable battery 52. The housing 60 and battery 52 have interactive parts that create a locking mechanism comprised of: protrusion(s) 64 on one side of the battery 52 that interlock with detent(s) 62 on one side of the housing, and detent(s) 66 on the other side of the battery 52 that receive locking mechanism 68 on the housing 60. The locking mechanism has a slider 72 that is exposed on the outer surface of the housing 60 that is spring loaded by a spring 74 in a locked position. The user can remove the battery by sliding the slider against the compressive force of the spring 74 to withdraw the latch 68 from the detents 66 and remove the battery. The Battery 52 and the housing 60 also have mating connectors 80 and 82 respectively for making electrical contact between the battery and the housing electronics 90. The electronics 90 are electrically connected to port(s) 92 for receiving power cable 100 connector 102.

It should be appreciated that FIG. 3 is an illustration of one type of configuration for a removable battery. In fact the embodiment illustrated is of a better of the type used by a tablet computer by Motion Computing, Inc. in its tablet PC products. In fact in a preferred embodiment of the invention the preferred battery a battery that is interchangeable with the replaceable rechargeable batter of the mobile computing device 10 used by the user. In this way the user can interchange batteries between her PC and her peripheral device power supply. However, in other embodiment different types of batteries by be used. The batteries are preferably rechargeable and preferably removable. However, it is not necessary that the battery be removed in the same manner described herein.

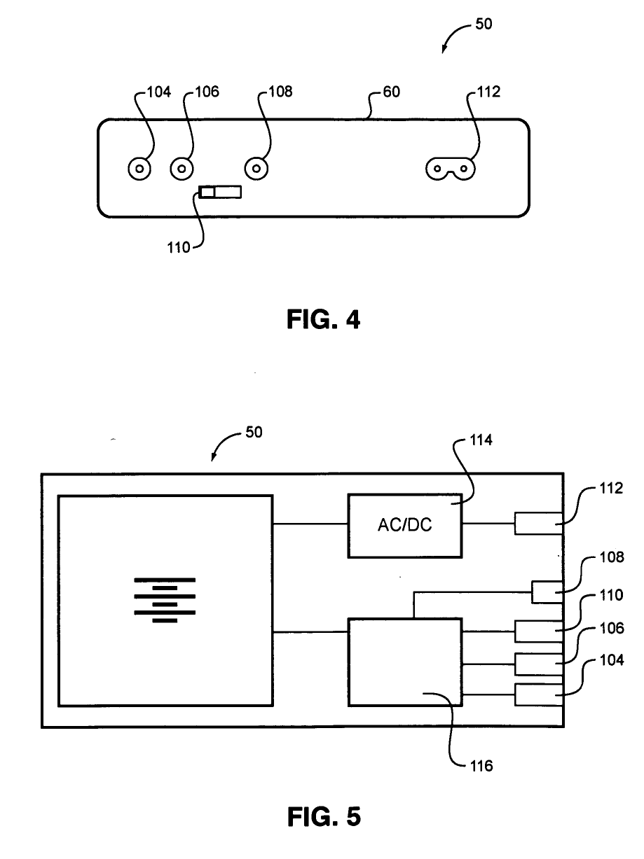

FIG. 4 illustrates the front panel ports of one embodiment of the peripheral power supply. This embodiment includes a ports 104 106 and 108. It provides two ports 104 and 106 which can supply 5V power to two different peripheral devices. The embodiment also provides one port 108 which can supply 12V power to a peripheral device. The embodiment also provides a switch 110 which lets the user determine if she wants to activate the 5V ports or the 12V ports. In alternative embodiments, only one output voltage may be supplied. In yet other embodiments multiple voltages may be supplied at one time. In some embodiments one of the voltages that may be output is the voltage used to charge the removable battery commonly 19V. With this output, the peripheral power supply can also be connected to the mobile computer to supply it power to operate and to charge its battery. It is well within the capabilities of an electronic engineer to design the required circuitry if given the battery

FIG. 5 illustrates the functional blocks of the circuitry of the peripheral power supply illustrated in FIG. 4. The battery 52 is connected to an AC/DC transformer 120 that converts AC power supplied to the device through socket 112. Although a wound core ballast transformer may be used, it would be preferable to employ the use of an electronic transformer since such transformers are much lighter take less room and in many cases can charge the battery more rapidly. The battery 52 is also connected to a DC/DC converter 116 that can convert the voltage provided by the battery 52 into different voltage(s) to be supplied to appropriate voltage sockets 104, 106 and 108.

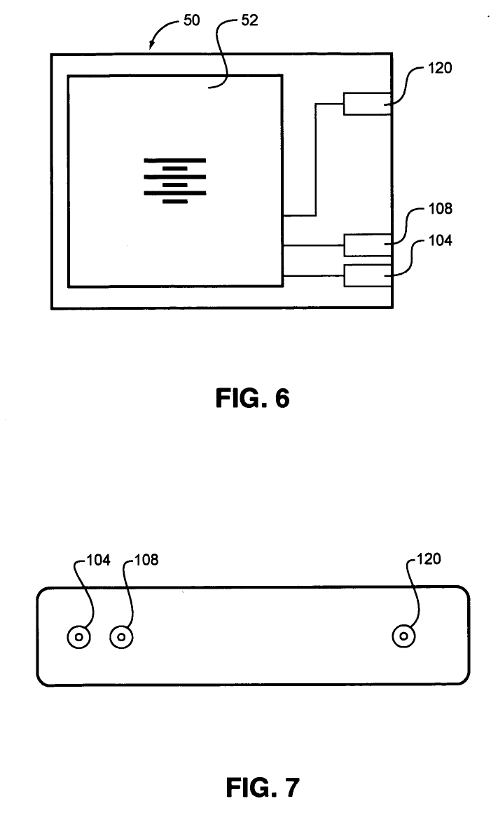

FIG. 6 illustrates functional blocks of the circuitry of an alternative peripheral power supply design. In this design there is no AC/DC converter. This alternative power supply must be connected to the Power utility AC grid via a power cable (not shown) that includes an AC/DC converter inline (not shown). Rather this peripheral power supply provides a socket 120 for receiving DC power at the voltage necessary to charge the battery 52. The embodiment illustrated in FIG. 6 also does not have DC/DC circuitry. This circuitry is not necessary in three circumstances: (1) if the batter already puts out the desired voltage, or (2) the output voltage is lower than the highest output voltage of the battery and the battery provides intermittent access to individual battery cells or subgroups of cells or (3) the battery already otherwise provides internal circuitry for providing multiple voltage outputs. The peripheral power supply illustrated in FIG. 6 provides multiple output voltages 114 and 116 via making appropriate electrical connections between the output ports 114 and 116 to the appropriate electrical contacts 80 on the battery 52 which either has internal voltage converters or provides access to individual cells or groups of cells so that the desired scaled down voltage can be obtained.

FIG. 7 illustrates the front panel connection sockets for the peripheral power supply illustrated in FIG. 6—including socket 120 for receiving DC battery input for charging the battery and output sockets 104 and 108 for outputting different voltages for the needs of different peripherals.

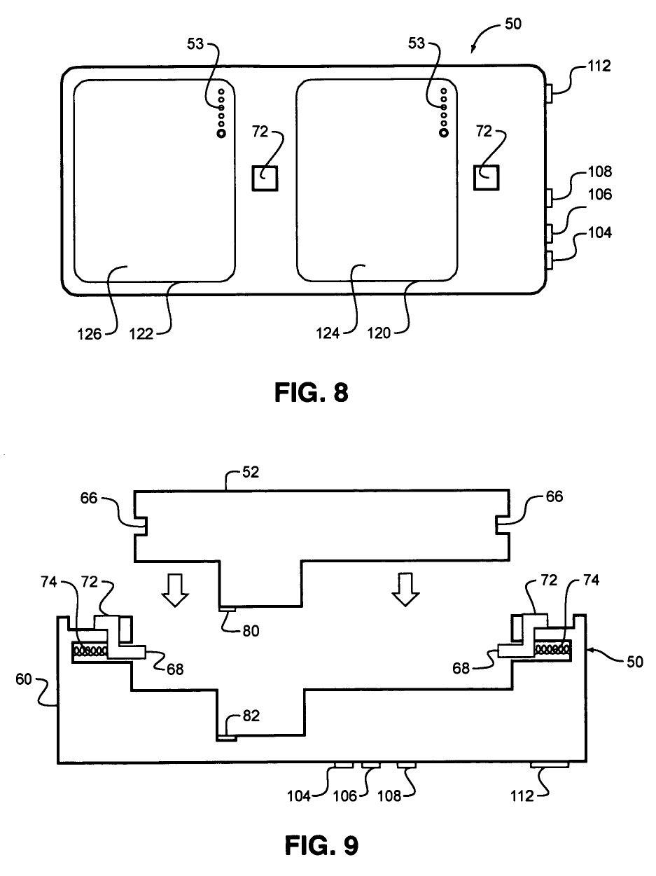

FIG. 8 illustrates an alternative embodiment of the peripheral power supply which has multiple slots 120 and 122 for receiving multiple removable rechargeable batteries 124 and 126. In some embodiments of this alternative design both batteries are charged together. In other embodiments the supply contains circuitry for completing the charge of the first battery 124 prior to charging the second battery 126.

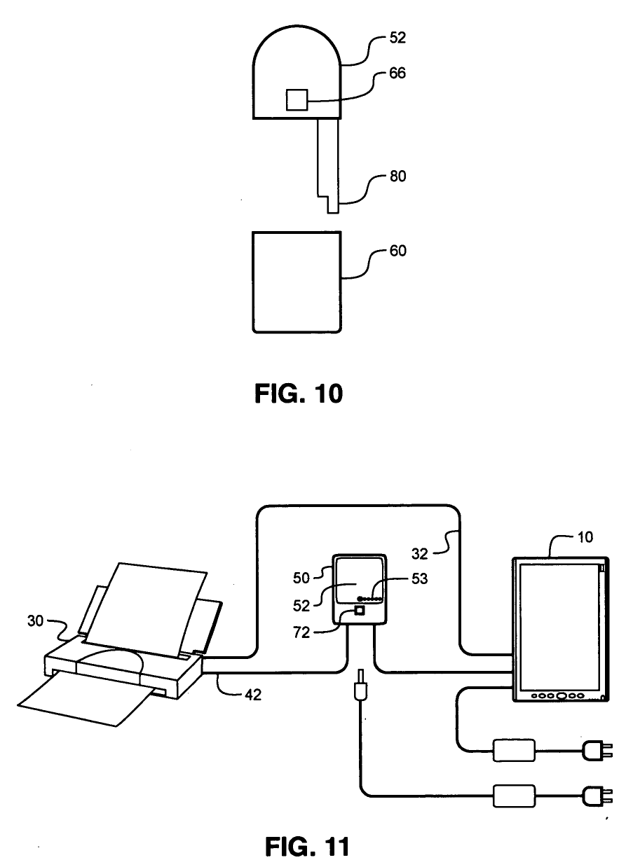

FIG. 9 illustrates yet another embodiment of the peripheral power supply using designed to receive an elongated generally cylindrical removable rechargeable battery 52. FIG. 10 illustrates a side view of the embodiment illustrated in FIG. 9.

FIG. 11 illustrates yet another configuration of the peripheral power supply. In this case the peripheral power supply is charged through the computer 10. In the preferred embodiment of this configuration. Either the computer or the peripheral power supply contains circuitry for sensing whether the computer is running off of its battery (not shown) or mains power from the utility grid (not shown, Either the computer 10 or the power supply may also have sensing circuitry for sensing whether the computer battery is substantially fully charged). If not connected to mains power the peripheral battery will not be charged. If connected to mains power then the battery may charge either along with the computer battery or after the computer battery is fully charged depending the embodiment desired order. In alternative embodiments the user is provided with a software to choose the setup configuration preferences of how to set priorities for battery charge and/or usage.

In the preferred embodiment illustrated in FIG. 11, the battery in the peripheral power supply is of the same type, and interchangeable with the battery used by the computer. This provides the advantage of greater flexibility to the user as to how to use her stored power. The user can travel with two batteries the second battery can either be used as an auxiliary battery for the computer or can be used to power her peripheral devices.

The peripheral power device 50 illustrated in FIG. 11 can receive charging power either through the computer 10 or directly from a power cord 130 with an inline AC/DC transformer 132 when plugged into the power grid (not shown).

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A mobile computing system comprising:
(a) a mobile computer with a first mobile computer battery power source;
(b) a mobile computer peripheral device; and
(c) a power supply for the peripheral computer device employing a second mobile computer battery power source.

2. The mobile computing system of claim 1 wherein the first mobile computer battery power source and the second mobile computer battery power source are of the same configuration.

3. The mobile computer system of claim 2 wherein the first mobile computer battery power source and the second mobile computer battery power source are of the same type.

4. The mobile computer system of claim 1 wherein the peripheral device is an optical drive.

5. The mobile computer system of claim 1 wherein the peripheral device is a printer.

6. The mobile computer system of claim 1 wherein the peripheral device is a scanner.

7. The mobile computer system of claim 1 wherein the power supply for the peripheral computer device employing the second mobile computer battery also can receive power from a conventional power grid to charge the second mobile computer battery.

8. The mobile computer system of claim 2 wherein the power supply for the peripheral computer device employing the second mobile computer battery includes an AC to DC power transformer capable of transforming alternating current power from a conventional power grid to direct current power to charge the second mobile computer battery.

9. The mobile computer system of claim 7 wherein the power supply for the peripheral computer device has an output for providing power to the mobile computer thereby charging the first mobile computer battery.

10. A power supply for computing system peripherals comprising:
(a) a first mobile computer battery power source;
(b) a housing for receiving said mobile computer battery;
(c) power transmission circuitry in said housing generating the desired voltage for powering a peripheral device; and
(c) a power port providing access to said desired voltage for powering a peripheral device.

11. The power supply of claim 10 wherein:
(a) the battery has electrical contacts for tapping different voltages from the battery; and
(b) power transmission circuitry generating the desired voltage directly from the battery contacts to said power port.

12. The power supply of claim 10 wherein the power transmission circuitry converts voltage tapped from the battery to a desired voltage for powering a peripheral device.

13. The power supply of claim 10 wherein the power is provided to an optical drive.

14. The power supply of claim 10 wherein the power is provided to a printer.

15. The power supply of claim 10 wherein the power is provided to a scanner.

16. The power supply of claim 10 wherein the power supply for the peripheral computer device employing the mobile computer battery includes an AC-DC transformer capable of transforming alternating current power from a conventional power grid to direct current to charge the mobile computer battery.

17. The Power Supply of claim 16 wherein the power supply for the peripheral computer device has an output for providing power to a mobile computer.

18. A power supply for computing system peripherals comprising:
(a) a first mobile computer battery power source;
(b) a housing for receiving said mobile computer battery;
(c) an AC-DC transformer capable of receiving alternating current power from a power grid and outputting direct current for charging the mobile computer battery;
(d) power transmission circuitry transmitting power from the battery to a desired voltage for powering a peripheral device; and
(e) a power port providing access to said desired voltage for powering a peripheral device.

19. The power supply of claim 18 wherein the power transmission circuitry generates a plurality of different voltages to provide power to peripheral devices with differing power requirements.

20. The power supply of claim 18 wherein the power transmission circuitry can simultaneously provide the plurality of different voltages.
